(19) United States
(12) Patent Application Publication
(10) Pub. No.: US 2011/0309646 A1
(43) Pub. Date: Dec. 22, 2011

(54) Weldan Puller

(76) Inventor: Danny Wells, Bowmanville (CA)

(21) Appl. No.: 13/158,311

(22) Filed: Jun. 10, 2011

Related U.S. Application Data
(60) Provisional application No. 61/357,259, filed on Jun. 22, 2010.

(51) Int. Cl. B25J 1/00; B25J 1/04

(52) U.S. Cl. 294/175

(57) ABSTRACT

A telescopic tractor/trailer uncoupling tool for uncoupling a fifth wheel trailer from a tractor unit. The device may be used to hook a ring affixed to the spring loaded jaw release pin on a fifth wheel towing apparatus. The invention may be an extendable telescoping tool approximately thirty six inches in length when extended, with a hook affixed on a second or third slidable segment and a handle affixed opposite on the main column. The third segment slides into the second, the second segment nestably slides into the column when placed in the storage position wherein all segments are nestably housed within the column at a total length of approximately two feet or less. The device allows for in-cab storage because of the short storage length, and for conveniently reaching the jaw release pin handle when extended.

### CROSS-REFERENCE TO RELATED APPLICATION

The present application is related to and claims priority from prior provisional application Ser. No. 61/357,259, filed Jun. 22, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of semi tractor/trailer uncoupling tools and more specifically relates to telescoping semi tractor/trailer uncoupling tools.

2. Description of the Related Art

In modern society, goods and raw materials are shipped mainly by tractor trailer combination vehicles over the nation's highways from one location to another for processing, manufacturing, and/or delivery for sale. The tractor may be coupled to the trailer via a fifth wheel coupling. The fifth wheel coupling is typically a turntable type apparatus bolted to the deck of the tractor having a latching mechanism to receive and lock onto a pin, (or a king pin) when coupled to the trailer for hauling. The king pin is attached to the bottom of the semi trailer and protrudes vertically downward through the center of a circular plate, on which it rests and pivots when in use. To uncouple the semi trailer from the tractor, the truck driver has to descend from the cab of the tractor and manually pull a spring loaded pin that locks the jaws of the fifth wheel onto the king pin. To do this, the driver typically uses a tool that has a column, a handle on one end, a hook on the other end, and is about three feet long. The tool, or puller as it may also be called, is used to make reaching in between the trailer and the tractor bed to grip the ring attached to the end of the spring loaded release pin easier and safer.

Current pullers pose a variety of problems for transport drivers. Traditional pullers are constructed at 36″ in length and do not possess telescopic capabilities, making them too long for certain jobs. Because of the excessive length, pullers may be too large to be stored inside vehicles and must therefore be stored outside. However, these subjects pullers tend to rust and incur other environmental damage when stored on the exterior of the tractor, and may allow pullers to be easily stolen. If pullers are stolen or damaged, drivers may be forced to purchase expensive replacements. A compact, convenient product is necessary.

Various attempts have been made to solve the above-mentioned problems such as those found in U.S. Pat. Nos. 4,050,107; 4,778,181; D370,605; RE28,879; 4,351,126; and 6,935,664. This prior art is representative of uncoupling tools. None of the above inventions and patents, taken either singly or in combination, is seen to describe the invention as claimed.

Ideally, a semi tractor/trailer uncoupling tool should be compactable for storage and, yet, would operate reliably and be manufactured at a modest expense. Thus, a need exists for a reliable telescoping semi tractor/trailer uncoupling tool system that may be collapsed for easy and convenient storage during non-use periods and to avoid the above-mentioned problems.

### BRIEF SUMMARY OF THE INVENTION

In view of the foregoing disadvantages inherent in the known tractor/trailer uncoupling tool art, the present invention provides a novel telescopic tractor/trailer uncoupling tool system. The general purpose of the present invention, which will be described subsequently in greater detail is to provide a collapsible, compact sized tool for storage inside a tractor.

The telescopic tractor/trailer uncoupling tool as disclosed herein preferably comprises a column, a hook, and a handle. The handle may comprise a “T” shape, but in some embodiments the handle may comprise an “L” shape or a “D” shape (or the like.) The column is preferably a cylindrical shape with a cylindrical inner volume suitable for housing at least a first segment and a second segment in which the first segment and second segment are slidabley related to each other and to the column. The column may be rigidly attached to the handle and the hook is rigidly attached to the second segment. Other embodiments may have a third segment with a longer reach capacity (and a smaller embodiment when stored.)

The telescopic tractor/trailer uncoupling tool is slidably extendable (and retractable) and able to be locked into an extended telescoped position. This provides that the hook is removably attachable to a fifth-wheel release pin handle so that a user can pull the handle and with the hook, release a fifth-wheel trailer from a tractor unit. The hook preferably comprises a “J” shape suitable to easily hook into a circular ring such as a fifth wheel pin handle. The column comprises a stop such that the first and second segments may not become uncoupled from each other or from the column. When telescopic tractor/trailer uncoupling tool is fully extended into the telescoped position, the extended-length may be about three feet, but may be longer or shorter in other embodiments. The telescoping uncoupling tool is in a stored position when the first segment and the second segment are slidably retracted (substantially) within the column (nested therein) and is thus storable within the interior of the tractor unit. The column comprises a length of less than approximately two feet when placed in the storage position and may also be stored in a driver's door pocket within the tractor unit for convenience of use and to protect the item from being stolen.

A method of using a telescoping semi tractor/trailer uncoupling tool is also described herein preferably comprising the steps of: extending the first and second segments from a column; hooking and pulling a fifth wheel pin ring (release); and uncoupling the fifth wheel trailer from a tractor unit. The method may further comprise the step of retracting the first and second segments within the column to provide a storage condition (configuration.)

The present invention holds significant improvements and serves as a telescopic tractor/trailer uncoupling tool system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Weldan Puller Systems, constructed and operative according to the teachings of the present invention.

FIG. 1 shows a perspective view illustrating Weldan Puller Systems in an in-use (telescoped outwardly) condition according to an embodiment of the present invention.

FIG. 2 is a perspective view illustrating the Weldan Puller Systems in an extended (outwardly telescoped) condition according to an embodiment of the present invention of FIG. 1.

FIG. 3 is a perspective view illustrating the Weldan Puller Systems in a retracted storage (inwardly telescoped) condition according to an embodiment of the present invention of FIG. 1.

FIG. 4 is a flowchart illustrating a method of use for the Weldan Puller Systems according to an embodiment of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to an uncoupling device and more particularly to a telescopic tractor/trailer uncoupling tool as used to provide a tool efficiently sized for interior vehicular storage.

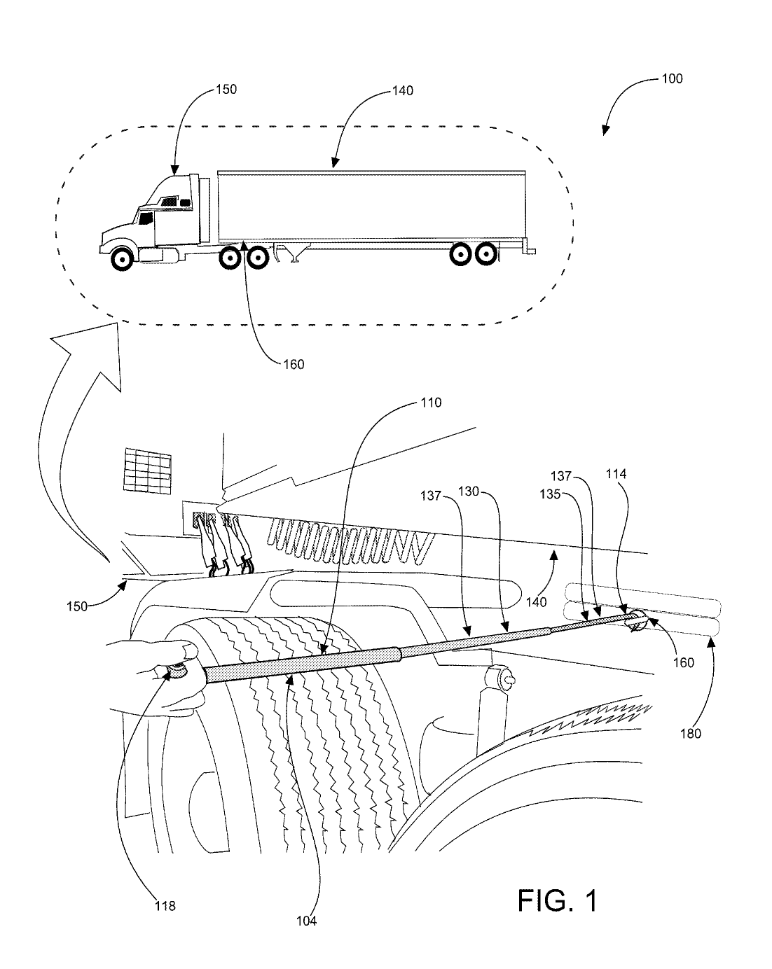

Referring to the drawings by numerals of reference there is shown in FIG. 1 a perspective view illustrating Weldan Puller Systems 100 in an in-use condition according to an embodiment of the present invention. Weldan Puller Systems 100 comprises a tool designed to release a fifth wheel trailer 140 from a tractor 150 and features a retractable construction, thereby increasing ease of use and portability. Weldan Puller Systems 100 telescopic tractor/trailer uncoupling tool 104 preferably comprises: column 110; hook 114 (hooking/grasping means); and handle 118. Column 110 comprises a cylindrical inner volume suitable for housing at least first segment 130 and second segment 135 and wherein first segment 130 and second segment 135 may be slidably related to each other and to column 110 (such that they may be telescoped inwardly or outwardly.) Column 110 may be rigidly attached to handle 118 and hook 114 may be rigidly attached to second segment 135 (or third segment in other embodiments.) In this way telescopic tractor/trailer uncoupling tool 104 may be slidably extendable and able to be locked into an extended telescoped position 310 such that hook 114 may be removably attachable to fifth-wheel release pin handle 160 such that a user can pull handle 118 via hook 114 to release fifth wheel trailer 140 from tractor 150 unit.

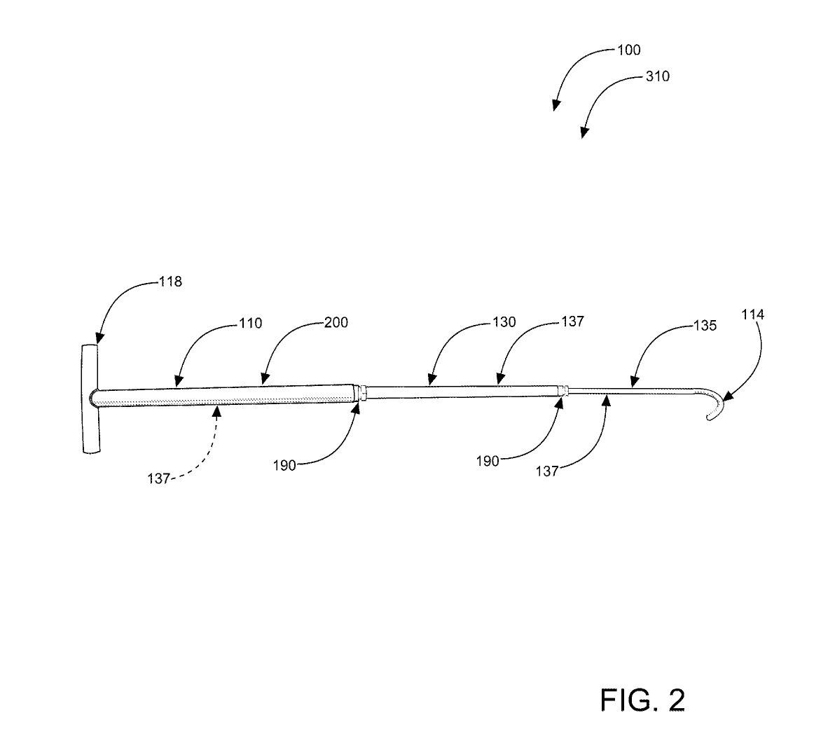

Referring now to FIG. 2, a perspective view illustrating Weldan Puller Systems 100 in an extended telescoped position 310 according to an embodiment of the present invention of FIG. 1.

Telescopic tractor/trailer uncoupling tool 104 is shown wherein extended telescoped position 310 comprises an extended-length of greater than about three feet (for suitable length to reach under trailer to uncouple keeping the user-operator at a safe distance.) For added versatility, the invention may be extended to 36″ in length, allowing transport drivers to access hard-to-reach places. Steel tubes 200 can be substantially enclosed (nested) inside of (primary) column 110 and may diminish in size to accommodate this nestable fitting orientation. Segments 137 (first segment 130 and second segment 135) may be interlocked, one inside the other, preferably with stop(s) 190 at each end of each segment 137. Telescopic tractor/trailer uncoupling tool 104 column 110 comprises stop(s) 190 such that first segment 130 and second segment 135 may not become uncoupled from column 110 (during in-use and non-use periods.) Telescopic tractor/trailer uncoupling tool 104 may further comprise third segment 210 in other embodiments of the invention. Telescopic tractor/trailer uncoupling tool 104 handle 118 may comprise “T” shape but in other embodiments may comprise an “L” shape or a “D” shape. Hook 114 may preferably comprise a “J” shape made of a ⅜″ steel rod.

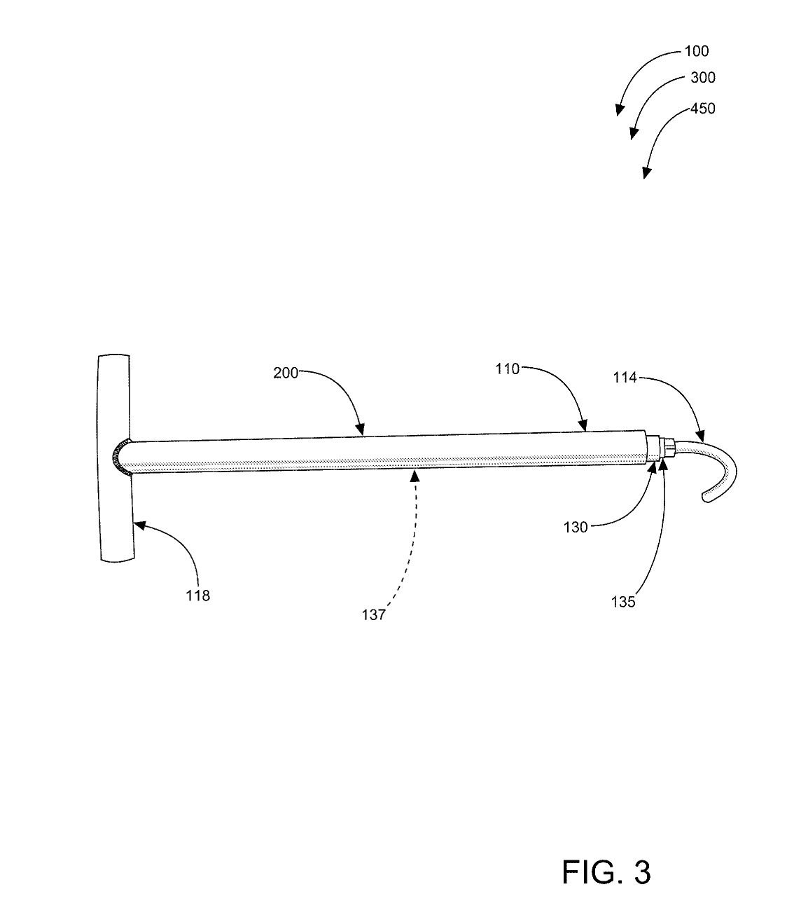

Referring now to FIG. 3, a perspective view illustrating Weldan Puller Systems 100 in a retracted storage condition 300 according to an embodiment of the present invention of FIG. 1. Telescopic tractor/trailer uncoupling tool 104 comprises retracted storage condition 300 when first segment 130 and second segment 135 are slidably retracted within column 110 such that telescopic tractor/trailer uncoupling tool 104 may be storable within an interior of tractor 150 unit. In this way the present invention is rendered convenient in-use.

Telescopic tractor/trailer uncoupling tool 104 when in retracted storage condition 300 may comprise a shortened length such that it may be stored in a driver's door pocket within tractor 150 unit preventing the risk of possible theft or damage to the device. Telescopic tractor/trailer uncoupling tool 104 retracted storage condition 300 preferably comprises a length of less than about two feet (preferably 14½ inches) or column 110 and may comprise a over-all length of less than two feet in some embodiments. In certain embodiments Weldan Puller Systems 100 may comprise kit 450; wherein other variously shaped hooks may be removably employed.

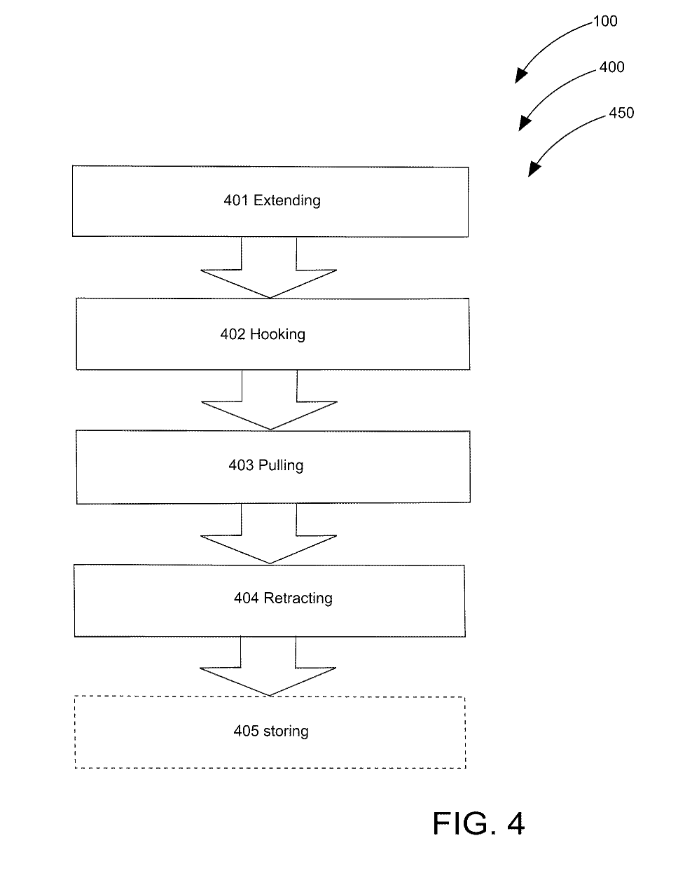

Referring now to FIG. 4 a flowchart 450 illustrating a method of use 400 for Weldan Puller Systems 100 which may comprise the steps of: step one 401 extending Weldan Puller Systems 100; step two 402 hooking fifth-wheel release pin handle 160; step three 403 pulling fifth-wheel release pin handle 160 to release fifth wheel jaws 180; step 404 slidably retracting Weldan Puller Systems 100 into a retracted storage condition 300; and optionally step five 405 storing Weldan Puller Systems 100 in an interior of tractor 150.

It should be noted that step 405 is an optional step and may not be implemented in all cases. Optional steps of method 400 are illustrated using dotted lines in FIG. 4 so as to distinguish them from the other steps of method 400. It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A telescopic tractor/trailer uncoupling tool comprising:
a column;
a first segment and a second segment;
a hook; and
a handle;
wherein said column comprises a cylindrical inner volume suitable for nestibly housing at least said first segment and said second segment;
wherein said first segment and said second segment are slidably related to each other and to said column;
wherein said column is rigidly attached to said handle;
wherein said hook is rigidly attached to said second segment; and
wherein said telescopic tractor/trailer uncoupling tool is slidably extendable and able to be locked into an extended telescoped position such that said hook is removably attachable by a user to a fifth-wheel release pin handle such that said user can pull said handle via said hook to release a fifth-wheel trailer from a tractor unit.

2. The telescoping semi tractor/trailer uncoupling tool of claim 1 wherein said handle comprises a “T” shape.

3. The telescoping semi tractor/trailer uncoupling tool of claim 1 wherein said handle comprises an “L” shape.

4. The telescoping semi tractor/trailer uncoupling tool of claim 1 wherein handle comprises a “D” shape.

5. The telescoping semi tractor/trailer uncoupling tool of claim 1 wherein said telescoping semi tractor/trailer uncoupling tool comprises a stored condition when said first segment and said second segment are slidably retracted nestably within said column such that said telescoping semi tractor/trailer uncoupling tool is storable within an interior of said tractor unit.

6. The telescoping semi tractor/trailer uncoupling tool of claim 1 further comprising a third segment.

7. The telescoping semi tractor/trailer uncoupling tool of claim 1 wherein said column comprises a length of less than two feet.

8. The telescoping semi tractor/trailer uncoupling tool of claim 1 wherein said storage condition comprises a length of less than about two feet.

9. The telescoping semi tractor/trailer uncoupling tool of claim 1 wherein said extended telescoped position comprises an extended-length of greater than about three feet.

10. The telescoping semi tractor/trailer uncoupling tool of claim 1 wherein said hook comprises a “J” shape.

11. The telescoping semi tractor/trailer uncoupling tool of claim 1 wherein said telescoping semi tractor/trailer uncoupling tool when in a retracted position can be stored in a driver's door pocket within said tractor unit.

12. The telescoping semi tractor/trailer uncoupling tool of claim 1 wherein said column comprises a stop such that said first and second segments may not become uncoupled from said column.

13. A telescopic tractor/trailer uncoupling tool comprising:
a column;
a first segment and a second segment;
a hook; and
a handle;
wherein said handle comprises a “T” shape or an “L” shape or a “D” shape;
wherein said column comprises a cylindrical inner volume suitable for nestably housing at least said first segment and said second segment, wherein said first segment and said second segment are nestably slidabley related to each other and to said column;
wherein said column comprises a stop such that said first and second segments may not become uncoupled from said column;
wherein said column is rigidly attached to said handle;
wherein said hook is rigidly attached to said second segment;
wherein said hook comprises a “J” shape;
wherein said telescoping semi tractor/trailer uncoupling tool comprises a stored position when said first segment and said second segment are slidably retractable within said column such that said telescoping semi tractor/trailer uncoupling tool is storable within an interior of said tractor unit;
wherein said telescoping semi tractor/trailer uncoupling tool when in a retracted position can be stored in a driver's door pocket within said tractor unit;
wherein said column comprises a length of less than two feet;
wherein said storage condition comprises a length of about two feet;
wherein said extended telescoped position comprises an extended-length of about three feet; and
wherein said telescopic tractor/trailer uncoupling tool is slidably extendable and able to be locked into an extended telescoped position such that said hook is removably attachable to a fifth-wheel release pin handle such that a user can pull said handle via said hook to release a fifth-wheel trailer from a tractor unit.

14. A method of using a telescoping semi tractor/trailer uncoupling tool comprising the steps of:
extending first and second segments from a column;
hooking and pulling a fifth wheel pin ring; and
uncoupling a fifth wheel trailer from a tractor unit.

15. The method of using a telescoping semi tractor/trailer uncoupling tool of claim 14 further comprising the step of retracting said first and said second segments within said column to comprise a storage position.
